(19) United States
(12) Patent Application Publication
(10) Pub. No.: US 2024/0405447 A1
(43) Pub. Date: Dec. 5, 2024

(54) ANTENNA MODULE AND COMMUNICATION DEVICE INCLUDING SAME

(71) Applicant: Murata Manufacturing Co., Ltd., Nagaokakyo-shi (JP)

(72) Inventors: Kaoru SUDO, Nagaokakyo-shi (JP); Natsumi MINAMITANI, Nagaokakyo-shi (JP)

(73) Assignee: Murata Manufacturing Co., Ltd., Nagaokakyo-shi (JP)

(21) Appl. No.: 18/798,881

(22) Filed: Aug. 9, 2024

Related U.S. Application Data
(63) Continuation of application No. PCT/JP2022/044161, filed on Nov. 30, 2022.

(30) Foreign Application Priority Data
Feb. 16, 2022 (JP) 2022-022339

(51) Int. Cl. H01Q 21/06; H01Q 1/42; H01Q 1/52

(52) U.S. Cl. CPC H01Q 21/062; H01Q 1/422; H01Q 1/526

(57) ABSTRACT

An antenna module includes: a substrate having a first main surface and a second main surface facing in opposite directions; a first radiating element that is disposed along the first main surface; an electronic component that is disposed on the second main surface side and is electrically connected to the first radiating element; and a molded body that is disposed on the second main surface side and covers the electronic component with a resin, and the first radiating element is disposed to straddle the substrate and the molded body.

### CROSS-REFERENCE TO RELATED APPLICATIONS

The present application is a continuation application of PCT/JP2022/044161, filed on Nov. 30, 2022, designating the United States of America, which is based on and claims priority to Japanese Patent Application No. JP2022-022339 filed on Feb. 16, 2022, the entire contents of each of which are incorporated herein by reference.

### TECHNICAL FIELD

The present disclosure relates to an antenna module and a communication device including the same.

### BACKGROUND ART

International Publication No. 2018/230475 (Patent Document 1) describes an antenna module in which a patch antenna is disposed on a main surface and a side surface of an L-shaped substrate. Japanese Unexamined Patent Application Publication No. 2021-78077 (Patent Document 2) describes an antenna module in which an electronic component is mounted in a recess of a substrate, and a patch antenna is disposed on a surface facing the recess of the substrate and on a side surface of the substrate.

With the antenna modules described in Patent Document 1 and Patent Document 2, it is possible to radiate a beam from a side surface of a substrate by a patch antenna disposed on the side surface of the substrate.

### CITATION LIST

### Patent Document

Patent Document 1: International Publication No. 2018/230475
Patent Document 2: Japanese Unexamined Patent Application Publication No. 2021-78077

### SUMMARY

### Technical Problems

Among other things, in the antenna modules in the related art described in Patent Document 1 and Patent Document 2, since it is necessary to provide a sufficient space for disposing the antenna on the side surface of the substrate, the thickness of the substrate cannot be made thinner than the width of the antenna. This is an obstacle to thinning the antenna module.

The present disclosure has been made to solve the above-described and other problems, and an aspect thereof is to enable radiation of radio waves from a side surface of a substrate and to cope with thinning of the antenna module.

### Solutions to Problems

An antenna module according to the present disclosure includes: a substrate having a first main surface and a second main surface facing in opposite directions; a first radiating element that is disposed along the first main surface; an electronic component that is disposed on a second main surface side and is electrically connected to the first radiating element; and a molded body that is disposed on the second main surface side and covers the electronic component with a resin, and the first radiating element is disposed to straddle the substrate and the molded body.

### Advantageous Effects of Disclosure

In the antenna module according to the present disclosure, it is possible to enable radiation of the radio waves from a side surface of the substrate and to cope with thinning of the antenna module.

### BRIEF DESCRIPTION OF DRAWINGS

FIG. 1 is a block diagram of a communication device to which an antenna module according to Embodiment 1 is applied.

FIG. 2 is a perspective view of the antenna module according to Embodiment 1.

FIG. 3 is a side perspective view of the antenna module according to Embodiment 1, and includes three sub FIGS. 3(A), 3(B), and 3(C).

FIG. 4 is a side perspective view of an antenna module according to Embodiment 2, and includes three sub FIGS. 4(A), 4(B), and 4(C).

FIG. 5 is a side perspective view of an antenna module according to Embodiment 3, and includes three sub FIGS. 5(A), 5(B), and 5(C).

FIG. 6 is a side perspective view of an antenna module according to Embodiment 4.

FIG. 7 is a side perspective view of an antenna module according to Embodiment 5.

FIG. 8 is a side perspective view of an antenna module according to Embodiment 6.

FIG. 9 is a side perspective view of an antenna module according to Embodiment 7.

FIG. 10 is a side perspective view of an antenna module according to Embodiment 8, and includes three sub FIGS. 10(A), 10(B), and 10(C).

FIG. 11 is a side perspective view of an antenna module according to Embodiment 9.

FIG. 12 is a side perspective view of an antenna module according to Embodiment 10.

FIG. 13 is a perspective view of the antenna module according to Embodiment 11.

### DESCRIPTION OF EMBODIMENTS

Hereinafter, embodiments of the present disclosure will be described in detail with reference to the accompanying drawings. The same or corresponding parts in the drawings will be denoted by the same reference numerals, and the description thereof will not be repeated.

### Embodiment 1

### (Basic Configuration of Communication Device)

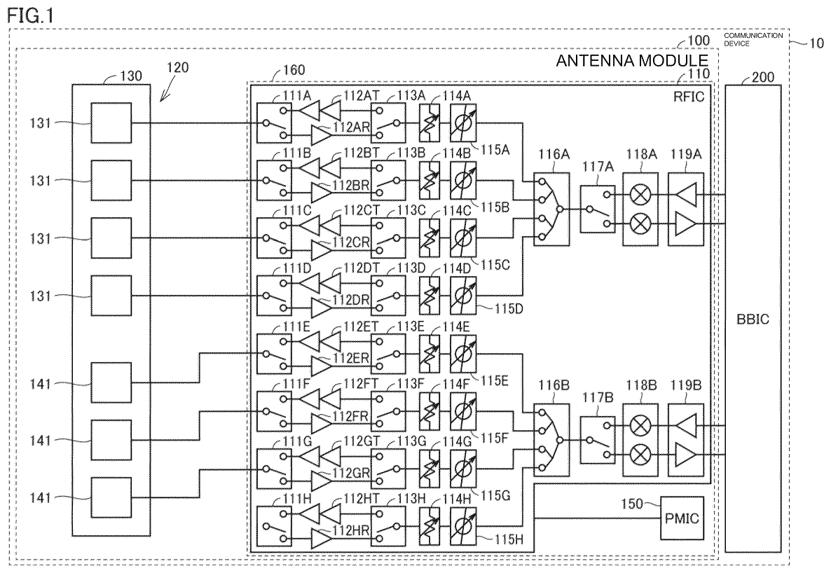

FIG. 1 is a block diagram of a communication device 10 to which an antenna module 100 according to the present Embodiment 1 is applied. The communication device 10 is, for example, a mobile terminal such as a mobile phone, a smartphone, a tablet, a personal computer having a communication function, or the like. An example of the frequency band of the radio wave used in the antenna module 100 according to the present embodiment is a millimeter wave band having, for example, a radio wave with a center frequency of 28 GHZ, 39 GHZ, 60 GHZ, or the like. The antenna module 100 according to the present embodiment can also be applied with radio waves in a frequency band other than the above.

With reference to FIG. 1, the communication device 10 includes an antenna module 100 and a base band integrated circuit (BBIC) 200 constituting a baseband signal processing circuit. The antenna module 100 includes a radio frequency (RF) integrated circuit (RFIC) 110, a power management integrated circuit (PMIC) 150, and an antenna device 120.

The RFIC 110 and the PMIC 150 are sealed in a system in package (SiP) 150. The PMIC 150 manages the power supply system of the RFIC 110. The RFIC 110 and the PMIC 150 are examples of a power supply circuit.

The communication device 10 up-converts a signal transmitted from the BBIC 200 to the antenna module 100 to a higher frequency signal (e.g., in the GHz range, and not to be confused with RF signals in the HF frequency band) and radiates the higher frequency signal from the antenna device 120, and down-converts to a lower frequency (and/or baseband) a signal at a higher frequency that is received at the antenna device 120 and processes the signal at the BBIC 200. The term high frequency is used herein to refer to a higher frequency signal in a generic contacts, such as in the GHz range, and not to be confused with RF signals restricted to the HF frequency band.

The antenna device 120 includes a dielectric substrate 130. The radiating elements 131 and 141 are disposed on the dielectric substrate 130. The radiating elements 131 and 141 are, for example, patch antennas having a substantially square flat plate shape, and are configured with the same dimensions. The radiating elements 131 and 141 may be configured as a dipole antenna.

The radiating elements 131 are disposed on the main surface side of the dielectric substrate 130, and the radiating elements 141 are disposed on the side surface side of the dielectric substrate 130. FIG. 1 shows an example in which four radiating elements 131 and three radiating elements 141 are disposed on the dielectric substrate 130. The number of the radiating elements 131 and 141 disposed on the dielectric substrate 130 may be one or two or more.

The RFIC 110 includes switches 111A to 111H, 113A to 113H, 117A, and 117B, power amplifiers 112AT to 112HT, low-noise amplifiers 112AR to 112HR, attenuators 114A to 114H, phase shifters 115A to 115H, signal synthesizer/power splitters 116A and 116B, mixers 118A and 118B, and amplifier circuits 119A and 119B.

Among these, the configuration of the switches 111A to 111D, 113A to 113D, and 117A, the power amplifiers 112AT to 112DT, the low-noise amplifiers 112AR to 112DR, the attenuators 114A to 114D, the phase shifters 115A to 115D, the signal synthesizer/power splitter 116A, the mixer 118A, and the amplifier circuit 119A is a circuit for a high frequency signal radiated from the radiating element 131.

The configuration of the switches 111E to 111H, 113E to 113H, and 117B, the power amplifiers 112ET to 112HT, the low-noise amplifiers 112ER to 112HR, the attenuators 114E to 114H, the phase shifters 115E to 115H, the signal synthesizer/power splitter 116B, the mixer 118B, and the amplifier circuit 119B is a circuit for the high frequency signal radiated from the radiating element 141. Since the fourth radiating element 141 is not disposed on the dielectric substrate 130 shown in FIG. 1, the signal path including the switch 111H is not connected to the radiating element.

In a case where the high frequency signal is transmitted, the switches 111A to 111H and 113A to 113H are switched to the power amplifiers 112AT to 112HT side, and the switches 117A and 117B are connected to the transmission side amplifiers of the amplifier circuits 119A and 119B. In a case where the high frequency signal is received, the switches 111A to 111H and 113A to 113H are switched to the low-noise amplifiers 112AR to 112HR side, and the switches 117A and 117B are connected to the receiving side amplifiers of the amplifier circuits 119A and 119B.

The signal transmitted from the BBIC 200 is amplified by the amplifier circuits 119A and 119B and up-converted by the mixers 118A and 118B. The transmission signal, which is an up-converted high frequency signal, is divided into four waves by the signal synthesizer/power splitters 116A and 116B, and passes through the corresponding signal paths, and each divided high frequency signal is fed to different radiating elements 131 and 141, respectively. The directivity of the radio waves output from the radiating elements 131 and 141 can be adjusted by individually adjusting the phase shift of the phase shifters 115A to 115H disposed in each signal path.

The reception signal, which is the high frequency signal received by the radiating elements 131 and 141, is transmitted to the RFIC 110, and each reception signal is multiplexed in the signal synthesizer/power splitters 116A and 116B via different signal paths. The multiplexed reception signal is down-converted by the mixers 118A and 118B, amplified by the amplifier circuits 119A and 119B, and transmitted to the BBIC 200.

The RFIC 110 is formed as, for example, a one-chip integrated circuit component including the above-described circuit configuration. Alternatively, the device (switch, power amplifier, low-noise amplifier, attenuator, and phase shifter) corresponding to each of the radiating elements 131 and 141 in the RFIC 110 may be formed as a one-chip integrated circuit component for each of the corresponding radiating elements.

### (Overview of Configuration of Antenna Module)

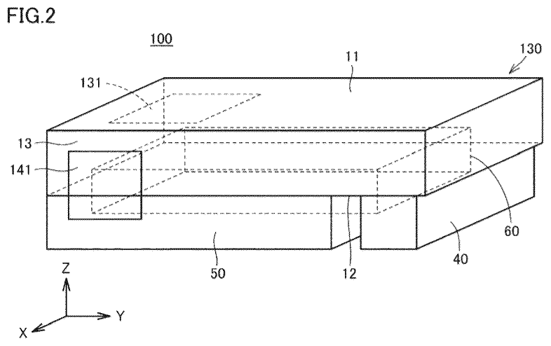

FIG. 2 is a perspective view of the antenna module 100 according to Embodiment 1. As shown in FIG. 2, the antenna module 100 is configured by combining the dielectric substrate 130, the molded body 50, and a connector 40.

Hereinafter, as shown in the drawings, a normal direction of the first main surface 11 of the dielectric substrate 130 is referred to as a “Z-axis direction”, a longitudinal direction of the dielectric substrate 130, which is perpendicular to the Z-axis direction, is referred to as a “Y-axis direction”, and a direction perpendicular to the Y-axis direction and the Z-axis direction is also referred to as an “X-axis direction”. In addition, in the following description, a positive direction of the Z axis in each figure may be referred to as an upper surface side, and a negative direction may be referred to as a lower surface side.

The molded body 50 and the connector 40 are attached to the second main surface 12 of the dielectric substrate 130. The first main surface 11 and the second main surface 12 are parallel to each other.

The molded body 50 is formed by filling a resin into a mold together with the electromagnetic wave shield 60 accommodating a SiP 160. In the step of forming the molded body 50, the mold is filled between the wall surface of the electromagnetic wave shield 60 and the SiP 160. In FIG. 2, the SiP 160 accommodated in the electromagnetic wave shield 60 is not shown. The electromagnetic wave shield 60 is a box body in which a bottom surface and four wall surfaces rising from the bottom surface are formed of metal, and an upper surface facing the second main surface 12 of the dielectric substrate 130 is open. The connector 40 is connected to the BBIC 200 shown in FIG. 1.

The radiating element 131 is disposed in the vicinity of the first main surface 11 of the dielectric substrate 130 to face the first main surface 11. The radiating element 141 is disposed on a side surface 13 of the dielectric substrate 130. As a result, the radiating element 131 and the radiating element 141 have a disposition relationship in which a direction of the radio wave radiated by the radiating element 131 and a direction of the radio wave radiated by the radiating element 141 are different from each other. In FIG. 2, an example is shown in which each of one radiating element 131 and one radiating element 141 are disposed on the dielectric substrate 130.

In particular, the radiating element 141 is disposed to be straddled across (i.e., straddles) the side surface 13 of the dielectric substrate 130 and the molded body 50. As described above, in the antenna module 100, the radiating element 141 positioned on the side surface 13 of the dielectric substrate 130 is disposed by using the space of the molded body 50 on the second main surface 12 side of the dielectric substrate 130. Therefore, the thickness of the dielectric substrate 130 can be reduced as compared with a case where the radiating element 141 is disposed by using only the space of the side surface 13 of the dielectric substrate 130.

### (Configuration of Antenna Module)

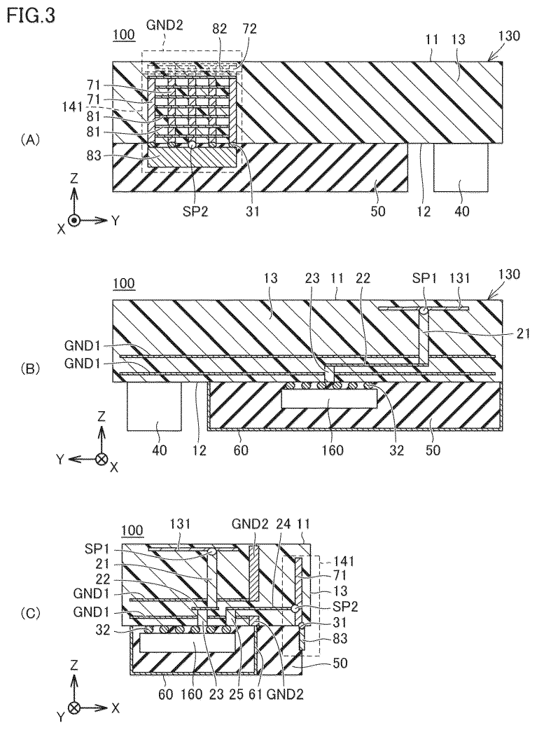

Next, a configuration of the antenna module 100 in the present Embodiment 1 will be described in detail with reference to FIG. 3, which includes 3 sub FIGS. 3(A), 3(B), and 3(C). FIG. 3 is a side perspective view of an antenna module 100 according to Embodiment 1.

FIG. 3(A) shows a side perspective view when the antenna module 100 is viewed in a plan view in the positive direction of the X axis, FIG. 3(B) shows a side perspective view when the antenna module 100 is viewed in a plan view in the negative direction of the X axis, and FIG. 3(C) shows a side perspective view when the antenna module 100 is viewed in a plan view in the positive direction of the Y axis.

The antenna module 100 includes the dielectric substrate 130, the molded body 50, and the connector 40.

When viewed in a plan view in a normal direction (Z-axis direction), the dielectric substrate 130 has a substantially rectangular shape. The dielectric substrate 130 is, for example, a low temperature co-fired ceramics (LTCC) multilayer substrate. The dielectric substrate 130 may be formed of a multilayer resin substrate formed by laminating a plurality of resin layers made of a resin such as epoxy and polyimide.

The dielectric substrate 130 may be formed of a multilayer resin substrate formed by laminating a plurality of resin layers each composed of a liquid crystal polymer (LCP) having a lower dielectric constant. The dielectric substrate 130 may be formed of a multilayer resin substrate formed by laminating a plurality of resin layers made of fluororesin, a multilayer resin substrate formed by laminating a plurality of resin layers made of polyethylene terephthalate (PET) material, or a ceramic multilayer substrate other than LTCC.

The dielectric substrate 130 need not necessarily have a multilayer structure, and may be a single layer substrate. A configuration corresponding to the dielectric substrate 130 may be molded by a 3D printer.

The connector 40 and the molded body 50 are disposed on the second main surface 12 of the dielectric substrate 130. The SiP 160 is disposed in the molded body 50. The SiP 160 is covered with the electromagnetic wave shield 60. The space between the electromagnetic wave shield 60 and the SiP 160 is filled with the resin constituting the molded body 50 without any gap. The SiP 160 and the dielectric substrate 130 are bonded to each other by a plurality of solder bumps including a solder bump 32.

The radiating element 131 and the radiating element 141 are disposed on the dielectric substrate 130. The radiating element 131 is disposed on the dielectric substrate 130 to face the first main surface 11. The radiating element 131 may be disposed to be exposed on the surface of the dielectric substrate 130. The radiating element 141 is disposed to be straddled across the dielectric substrate 130 and the molded body 50 at a position of the side surface 13 of the dielectric substrate 130. The radiating element 141 is an example of a first radiating element that is disposed along the first main surface 11, and the radiating element 131 is an example of a second radiating element that is disposed on the first main surface 11 side with respect to the second main surface 12.

As described above, the radiating element 131 and the radiating element 141 are disposed such that the normal directions thereof are different from each other. Therefore, the radiation direction of the radio wave of the radiating element 131 is different from the radiation direction of the radio wave of the radiating element 141. Specifically, the radiating element 131 radiates the radio wave in the substantially Z-axis direction, and the radiating element 141 radiates the radio wave in the substantially Y-axis direction.

A power feeding point SP1 of the radiating element 131 is offset from the center of the radiating element 131 in the X-axis direction when the dielectric substrate 130 is viewed in a plan view in the normal direction. The power feeding point SP1 of the radiating element 131 is connected to the electronic components such as the RFIC 110 and the PMIC 150 in the SiP 160 by the power feeding lines 21 to 23 extending from the solder bumps 32. A ground electrode GND1 facing the radiating element 131 is formed on the dielectric substrate 130.

A power feeding point SP2 of the radiating element 141 is offset from the center of the radiating element 141 in the Z-axis direction when the dielectric substrate 130 is viewed in a plan view in the X-axis direction. The power feeding point SP2 of the radiating element 141 is connected to the electronic components such as the RFIC 110 and the PMIC 150 in the SiP 160 by the power feeding lines 24 and 25 extending from the solder bumps 32.

A ground electrode GND2 facing the radiating element 141 is formed on the dielectric substrate 130. As shown in FIG. 3(C), the ground electrode GND2 is electrically connected to a wall surface 61 of the electromagnetic wave shield 60. The wall surface 61 faces the radiating element 141. Therefore, the wall surface 61 of the electromagnetic wave shield 60 constitutes the ground electrode of the radiating element 141 together with the ground electrode GND2. That is, in the antenna module 100, the ground electrode facing the radiating element 141 is disposed to be straddled across the dielectric substrate 130 and the molded body 50.

As shown in FIG. 3(A), the radiating element 141 disposed to be straddled across the dielectric substrate 130 and the molded body 50 has an element part configured in a mesh shape and an element part configured in a flat plate shape. The element part on the dielectric substrate 130 side is formed by arranging vias 71 filled with a conductive member and plate electrodes 81 in a lattice shape. The element part on the molded body 50 side is composed of a solid plate electrode 83 having conductivity. The via 71 and the plate electrode 83 are electrically connected to each other with a solder bump 31 interposed therebetween. The plate electrode 83 is an example of a conductive member that connects the adjacent vias 71 among the plurality of vias 71. An electrode density of the element part (first element part) configured in a mesh shape is lower than an electrode density of the element part (second element part) configured in a flat plate shape. Therefore, the electrode density of the electrode surface in the element part configured in a mesh shape and the electrode density of the electrode surface in the element part configured in a flat plate shape are different from each other. It should be noted that, here, an example is described in which the element part on the molded body 50 side is composed of the plate electrode 83. However, the element part on the molded body 50 side may be configured in a mesh shape having a higher electrode density than the element part on the dielectric substrate 130 side.

As shown in FIG. 3(A), the ground electrode GND2 disposed on the dielectric substrate 130 at a position facing the radiating element 141 is formed by arranging the vias 72 filled with a conductive member and the plate electrodes 82 in a lattice shape. Therefore, the ground electrode GND2 is configured in a mesh shape. FIG. 3(A) shows a part of a configuration of GND2.

In FIG. 3(C), the via 71 and the plate electrode 83 that constitute the radiating element 141 are not flush with each other but are connected to each other with a slight shifted in the X-axis direction, but the via 71 and the plate electrode 83 may be connected flush with each other.

The antenna module 100 disclosed in FIG. 3 can be applied to a thin mobile information terminal, such as a smartphone, that radiates radio waves in different directions. In general, in the mobile information terminal, a radiating element is disposed at a position facing the display and at a position facing the side surface, thereby enabling the radiation of radio waves in different directions. In a case where the antenna module 100 is applied to such a mobile information terminal, the first main surface 11 of the dielectric substrate 130 is disposed to face a surface on which the display is disposed. Therefore, the side surface 13 of the dielectric substrate 130 faces the side surface of the mobile information terminal.

In the antenna module in the related art, the radiating element is disposed using only the substrate side surface facing the side surface of the mobile information terminal. Therefore, in the antenna module 100 in the related art, there is a problem that the thickness of the substrate cannot be made thinner than the dimensions of the radiating element.

Therefore, in the antenna module 100 according to Embodiment 1, the radiating element 141 is disposed to be straddled from the side surface 13 of the dielectric substrate 130 to the molded body 50. According to Embodiment 1, the radiating element 141 can be disposed not only on the side surface 13 of the dielectric substrate 130 but also in the space of the molded body 50, which can be effectively utilized. As a result, the thickness of the dielectric substrate 130 can be reduced as compared with a case where the radiating element 141 is disposed by using only the space of the side surface 13 of the dielectric substrate 130.

In Embodiment 1, the radiating element 141 may be provided on the side surface 13 of the dielectric substrate 130, and the radiating element 131 is not necessarily provided. That is, the present disclosure can also be applied to an antenna module that is a single-surface radiation instead of a double-surface radiation.

### Embodiment 2

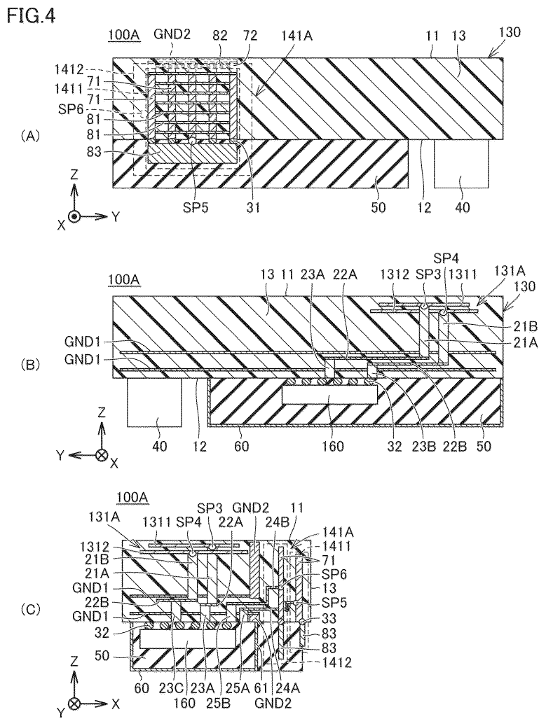

FIG. 4 is a side perspective view of an antenna module 100A according to Embodiment 2, and includes three sub FIGS. 4(A), 4(B), and 4(C).

FIG. 4(A) shows a side perspective view when the antenna module 100A is viewed in a plan view in the positive direction of the X axis, FIG. 4(B) shows a side perspective view when the antenna module 100A is viewed in a plan view in the negative direction of the X axis, and FIG. 4(C) shows a side perspective view when the antenna module 100A is viewed in a plan view in the positive direction of the Y axis.

The radiating elements 131 and 141 of the antenna module 100 according to Embodiment 1 radiate radio waves in one frequency band. In Embodiment 2, a configuration in which the features of the present disclosure are applied to a so-called dual band type antenna module in which radio waves in two different frequency bands can be radiated from a radiating element will be described.

In the antenna module 100A according to Embodiment 2, a radiating element 131A is disposed instead of the radiating element 131, and a radiating element 141A is disposed instead of the radiating element 141. The radiating element 131A includes a radiation electrode 1311 for radiating a radio wave in a first frequency band and a radiation electrode 1312 for radiating a radio wave in a second frequency band. The radiating element 141A includes a radiation electrode 1411 for radiating a radio wave in the first frequency band and a radiation electrode 1412 for radiating a radio wave in the second frequency band. As an example, the first frequency band is a 39 GHz band, and the second frequency band is a 28 GHz band.

All the radiation electrodes 1311, 1312, 1411, and 1412 have a substantially square shape. The radiation electrode 1311 and the radiation electrode 1312 are disposed to overlap with each other when the dielectric substrate 130 is viewed in a plan view in a normal direction. The radiation electrode 1411 and the radiation electrode 1412 are disposed to overlap with each other when the dielectric substrate 130 is viewed in a plan view in the Y-axis direction.

The dimensions of each side of the radiation electrode 1311 are shorter than the dimensions of each side of the radiation electrode 1312. Therefore, a frequency band of the radio waves radiated from the radiation electrode 1311 (first frequency band) is higher than a frequency band of the radio waves radiated from the radiation electrode 1312 (second frequency band). The dimensions of each side of the radiation electrode 1411 are shorter than the dimensions of each side of the radiation electrode 1412. Therefore, the sizes of the electrode surfaces of the radiation electrode 1411 and the radiation electrode 1412 are different from each other. Therefore, a frequency band of the radio waves radiated from the radiation electrode 1411 (first frequency band) is higher than a frequency band of the radio waves radiated from the radiation electrode 1412 (second frequency band).

A power feeding point SP3 of the radiation electrode 1311 is offset from the center of the radiating element 131A in the X-axis direction when the dielectric substrate 130 is viewed in a plan view in the normal direction. The power feeding point SP4 of the radiation electrode 1312 is offset from the center of the radiating element 131A in the Y-axis direction when the dielectric substrate 130 is viewed in a plan view in the normal direction.

A power feeding point SP5 of the radiation electrode 1411 is offset from the center of the radiating element 141A in the Z-axis direction when the dielectric substrate 130 is viewed in a plan view in the X-axis direction. A power feeding point SP6 of the radiation electrode 1412 is offset from the center of the radiating element 131A in the Y-axis direction when the dielectric substrate 130 is viewed in a plan view in the X-axis direction. In this manner, the offset direction from the center of the power feeding point in the radiation electrode 1411 and the offset direction from the center of the power feeding point in the radiation electrode 1412 are different from each other.

The power feeding point SP3 of the radiation electrode 1311 is connected to the electronic components such as the RFIC 110 and the PMIC 150 in the SiP 160 by the power feeding lines 21A to 23A extending from the solder bumps 32. The power feeding point SP4 of the radiation electrode 1312 is connected to the electronic components such as the RFIC 110 and the PMIC 150 in the SiP 160 by the power feeding lines 21B to 23B extending from the solder bumps 32.

The power feeding point SP5 of the radiation electrode 1411 is connected to the electronic components such as the RFIC 110 and the PMIC 150 in the SiP 160 by the power feeding lines 24A and 25A extending from the solder bumps 32. The power feeding point SP6 of the radiation electrode 1411 is connected to the electronic components such as the RFIC 110 and the PMIC 150 in the SiP 160 by the power feeding lines 24B and 25B extending from the solder bumps 32.

In Embodiment 2, two types of RFICs 110 corresponding to two frequency bands of the radio waves radiated from the radiating elements 131A and 141A are provided in the SiP 160. With such a configuration, it is possible to radiate radio waves in two different frequency bands from each of the first main surface 11 and the side surface 13 of the dielectric substrate 130.

In Embodiment 2, similarly to the Embodiment 1, the radiating element 141A on the side surface 13 side of the dielectric substrate 130 is also disposed to be straddled across the dielectric substrate 130 and the molded body 50. In Embodiment 2, similarly to the Embodiment 1, the radiation electrodes 1411 and 1412 of the radiating element 141A have an element part configured in a mesh shape and an element part configured in a flat plate shape.

In Embodiment 2, the radiation electrode 1411 is an example of a first electrode of the first radiating element, and the radiation electrode 1412 is an example of a second electrode of the first radiating element.

### Embodiment 3

FIG. 5 is a side perspective view of an antenna module 100B according to Embodiment 3, and includes three sub FIGS. 5(A), 5(B), and 5(C).

FIG. 5(A) shows a side perspective view when the antenna module 100B is viewed in a plan view in the positive direction of the X axis, FIG. 5(B) shows a side perspective view when the antenna module 100B is viewed in a plan view in the negative direction of the X axis, and FIG. 5(C) shows a side perspective view when the antenna module 100B is viewed in a plan view in the positive direction of the Y axis.

The radiating elements 131 and 141 of the antenna module 100 according to Embodiment 1 radiate a single radio wave in the polarization direction. In Embodiment 3, a configuration in which the features of the present disclosure are applied to a so-called dual polarization type antenna module capable of radiating polarized waves in two different directions from the radiating element will be described.

In the antenna module 100B according to Embodiment 3, a radiating element 131B is disposed instead of the radiating element 131, and a radiating element 141B is disposed instead of the radiating element 141.

A power feeding point SP7 of the radiating element 131B is offset from the center of the radiating element 131B in the X-axis direction when the dielectric substrate 130 is viewed in a plan view in the normal direction. A power feeding point SP8 of the radiating element 131B is offset from the center of the radiating element 131B in the Y-axis direction when the dielectric substrate 130 is viewed in a plan view in the normal direction. As a result, the radiating element 131B radiates the radio wave having the X-axis direction as the polarization direction and the radio wave having the Y-axis direction as the polarization direction.

A power feeding point SP9 of the radiating element 141B is offset from the center of the radiating element 141B in the Z-axis direction when the dielectric substrate 130 is viewed in a plan view in the X-axis direction. A power feeding point SP10 of the radiating element 141B is offset from the center of the radiating element 141B in the Y-axis direction when the dielectric substrate 130 is viewed in a plan view in the X-axis direction. As a result, the radiating element 141B radiates the radio wave having the X-axis direction as the polarization direction and the radio wave having the Z-axis direction as the polarization direction.

As described above, in each of the radiating elements 131B and 141B, the high frequency signal is supplied to the two power feeding points. As a result, each of the radiating elements 131B and 141B can radiate two radio waves having different polarization directions. That is, the antenna module 100B is a dual polarization type antenna module that can radiate the radio wave having the polarization direction in the first direction and the radio wave having the polarization direction in the second direction different from the first direction.

The power feeding point SP7 of the radiating element 131B is connected to the electronic components, such as the RFIC 110 and the PMIC 150, in the SiP 160 by the power feeding lines 21C to 23C extending from the solder bumps 32. The power feeding point SP8 of the radiating element 131B is connected to the electronic components, such as the RFIC 110 and the PMIC 150, in the SiP 160 by the power feeding lines 21D to 23D extending from the solder bumps 32.

The power feeding point SP9 of the radiating element 141B is connected to the electronic components, such as the RFIC 110 and the PMIC 150, in the SiP 160 by the power feeding lines 24C to 27C extending from the solder bumps 32. The power feeding point SP10 of the radiating element 141B is connected to the electronic components, such as the RFIC 110 and the PMIC 150, in the SiP 160 by the power feeding lines 24D and 25D extending from the solder bumps 32.

In Embodiment 3, similarly to the Embodiment 1, the radiating element 141B on the side surface side of the dielectric substrate 130 is also disposed to be straddled across the dielectric substrate 130 and the molded body 50. The radiating element 141B includes an element part configured in a mesh shape and an element part configured in a flat plate shape.

It should be noted that a so-called dual band and dual polarization type antenna module can also be configured by combining Embodiment 2 and the Embodiment 3.

### Embodiment 4

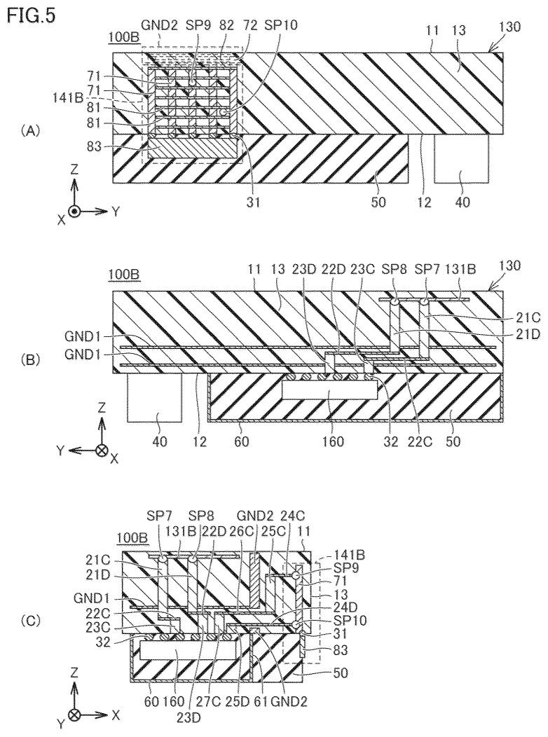

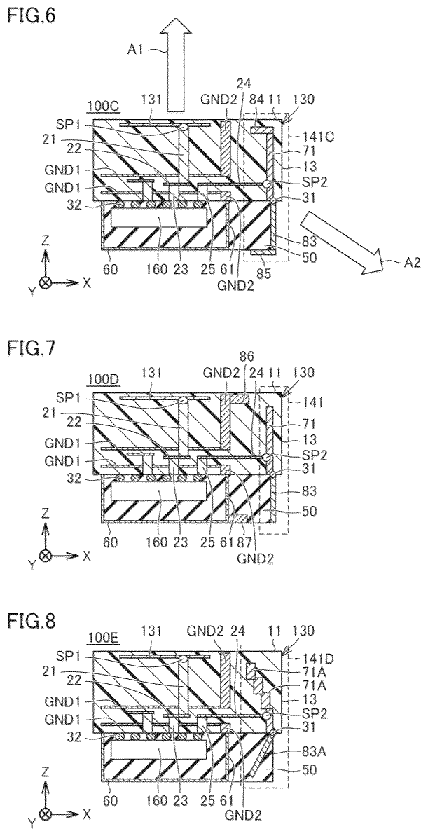

FIG. 6 is a side perspective view of an antenna module 100C according to Embodiment 4.

The antenna module 100C according to Embodiment 4 is different from the antenna module 100 according to Embodiment 1 in the shape of the radiating element disposed to be straddled across the side surface 13 of the dielectric substrate 130 and the molded body 50. The radiating element 141 of the antenna module 100 of Embodiment 1 is formed in a straight line along the Z axis when the dielectric substrate 130 is viewed in a plan view in the Y-axis direction (when the dielectric substrate 130 is viewed in a side view).

In the antenna module 100C according to Embodiment 4, the radiating element 141C is adopted instead of the radiating element 141. When the dielectric substrate 130 is viewed in a plan view in the Y-axis direction, both end portions of the radiating element 141C are composed of plate electrodes 84 and 85. The plate electrodes 84 and 85 are disposed to extend toward the ground electrode GND2 with respect to both ends of the via 71 constituting a part of the radiating element 141C.

The plate electrode 84 is an example of a first end portion of the radiating element 141C. The plate electrode 85 is an example of a second end portion of the radiating element 141C. When the dielectric substrate 130 is viewed in a side view in the side surface direction of the radiating element 141C, the plate electrode 84 extends toward the ground electrode GND2 from an inside of the ground electrode GND2 with respect to the end of the ground electrode GND2. When the dielectric substrate 130 is viewed in a side view in the side surface direction of the radiating element 141C, the plate electrode 85 extends toward the ground electrode GND2 from an outside of the ground electrode GND2 with respect to the end of the ground electrode GND2.

According to Embodiment 4, the dimensions of the radiating element disposed to be straddled across the side surface 13 of the dielectric substrate 130 and the molded body 50 can be made larger than those of Embodiment 1 by the amount of the plate electrodes 84 and 85, without changing the thickness of the dielectric substrate 130 from that of Embodiment 1. Therefore, even in a case where the thickness of the dielectric substrate 130 and the thickness of the molded body 50 are reduced in order to aim at the thinning of the antenna module 100C, the radiating element 141C can radiate the radio wave having a low frequency.

The plate electrode 84 on the dielectric substrate 130 side is disposed at a position lower than the distal end position of the ground electrode GND2 on the first main surface 11 side. On the other hand, the plate electrode 85 on the molded body 50 side is disposed on the surface of the molded body 50 at a position lower than the wall surface 61 of the electromagnetic wave shield 60.

Here, the wall surface 61 of the electromagnetic wave shield 60 functions as a ground electrode of the radiating element 141C together with the ground electrode GND2. Therefore, when the dielectric substrate 130 is viewed in a side view, in Embodiment 4, the radiating element 141C is disposed slightly shifted downward with respect to the ground electrode (the ground electrode GND2 and the wall surface 61) of the radiating element 141C.

Therefore, the radio wave of the radiating element 141C is radiated in the oblique direction indicated by the arrow A2. On the other hand, the radio wave of the radiating element 131 is radiated in the direction indicated by the arrow A1. As a result, with the antenna module 100C, it is possible to radiate the radio wave over a wide range from the direction indicated by the arrow A1 to the direction indicated by the arrow A2.

### Embodiment 5

FIG. 7 is a side perspective view of an antenna module 100D according to Embodiment 5. The antenna module 100D according to Embodiment 5 is different from the antenna module 100 according to Embodiment 1 in the shape of the ground electrode facing the radiating element 141. In the antenna module 100 according to Embodiment 1, the ground electrode facing the radiating element 141 is composed of the ground electrode GND2 and the wall surface 61 of the electromagnetic wave shield 60, and is formed in a straight line along the Z axis when the dielectric substrate 130 is viewed in a plan view in the Y-axis direction.

In the antenna module 100D according to Embodiment 5, the ground electrode facing the radiating element 141 is composed of the ground electrode GND2, the wall surface 61 of the electromagnetic wave shield 60, and the plate electrodes 86 and 87. The plate electrode 86 extends from the distal end on the first main surface 11 side of the ground electrode GND2 toward the radiating element 141. The plate electrode 87 extends from the electromagnetic wave shield 60 toward the radiating element 141. That is, when the dielectric substrate 130 is viewed in a side view in the side surface direction of the ground electrode GND2, both end portions (plate electrodes 86 and 87) of the ground electrode facing the radiating element 141 extend toward the radiating element 141.

Therefore, in Embodiment 5, when the antenna module 100D is viewed in a side view, both ends of the ground electrode of the radiating element 141 are composed of the plate electrodes 86 and 87. According to Embodiment 5, the dimensions of the ground electrodes of the radiating element 141 can be made larger than those of Embodiment 1 by the amount of the plate electrodes 86 and 87, without changing the thickness of the dielectric substrate 130 from that of Embodiment 1. Therefore, even in a case where the thickness of the dielectric substrate 130 and the thickness of the molded body 50 are reduced in order to aim at the thinning of the antenna module 100D, the radiating element 141 can radiate the radio wave having a low frequency.

### Embodiment 6

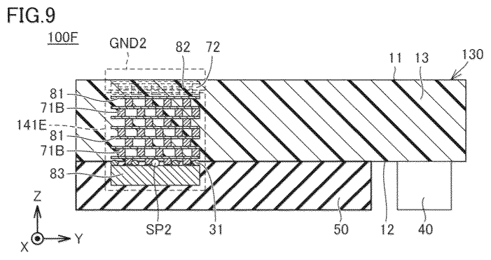

FIG. 8 is a side perspective view of an antenna module 100E according to Embodiment 6.

The antenna module 100E according to Embodiment 6 is different from the antenna module 100 according to Embodiment 1 in the shape of the radiating element disposed to be straddled across the side surface 13 of the dielectric substrate 130 and the molded body 50. The radiating element 141 of the antenna module 100 of Embodiment 1 is formed in a straight line along the Z axis when the dielectric substrate 130 is viewed in a plan view in the Y-axis direction.

In the antenna module 100E according to Embodiment 6, the radiating element 141D is adopted instead of the radiating element 141. When the dielectric substrate 130 is viewed in a plan view in the Y-axis direction, the radiating element 141D is composed of a plurality of vias 71A disposed in a step shape and plate electrode 83A. The plurality of vias 71A are connected by a large number of plate electrodes (not shown), and have a mesh-like shape similarly to the radiating element 141 shown in FIG. 3(A).

The via 71A disposed on the boundary surface between the dielectric substrate 130 and the molded body 50 is electrically connected to the plate electrode 83A on the molded body 50 side by the solder bump 31. The plurality of vias 71A are laminated in an oblique direction to gradually approach the ground electrode GND2 from a position connected to the plate electrode 83A. The plate electrode 83A is disposed in an oblique direction toward the wall surface 61 of the electromagnetic wave shield 60 from a position connected to the via 71A.

Therefore, the radiating element 141D is disposed in an aspect in which the radiating element 141D is inclined toward the GND2 side and the wall surface 61 side with the boundary between the dielectric substrate 130 and the molded body 50 as a center. According to Embodiment 6, the dimensions of the radiating element disposed to be straddled across the side surface 13 of the dielectric substrate 130 and the molded body 50 can be made larger than those in Embodiment 1 without changing the thickness of the dielectric substrate 130 from that of Embodiment 1. Therefore, even in a case where the thickness of the dielectric substrate 130 and the thickness of the molded body 50 are reduced in order to aim at the thinning of the antenna module 100E, the radiating element 141D can radiate the radio wave having a low frequency.

### Embodiment 7

FIG. 9 is a side perspective view of an antenna module 100F according to Embodiment 7. The antenna module 100F according to Embodiment 7 is different from the antenna module 100 according to Embodiment 1 in the shape of the radiating element disposed to be straddled across the side surface 13 of the dielectric substrate 130 and the molded body 50. In the antenna module 100E according to Embodiment 7, the radiating element 141E is adopted instead of the radiating element 141.

When the dielectric substrate 130 is viewed in a plan view in the X-axis direction, the radiating element 141E has a part corresponding to the side surface 13 of the dielectric substrate 130 formed in a staggered pattern. A part of the radiating element 141E corresponding to the side surface 13 is composed of the plurality of stacked plate electrodes 81 and the via 71B disposed between the two plate electrodes 81. In the radiating element 141E, the plurality of vias 71B are disposed in a staggered pattern. By configuring the arrangement of the vias 71B in this manner, the current density can be made more uniform. As a result, according to Embodiment 6, the antenna characteristics can be improved.

### Embodiment 8

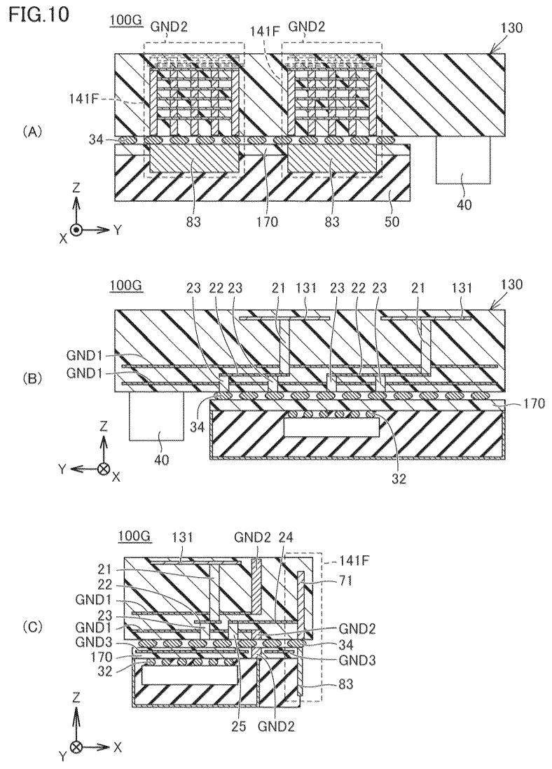

FIG. 10 is a side perspective view of an antenna module 100G according to Embodiment 8, and includes three sub FIGS. 10(A), 10(B), and 10(C). In the antenna module 100G according to Embodiment 8, a circuit board 170 is disposed between the dielectric substrate 130 and the molded body 50. A ground electrode GND3 is disposed on the circuit board 170. Further, the antenna module 100G according to Embodiment 8 constitutes an array antenna in which two radiating elements 131 and two radiating elements 141F are disposed.

The antenna module 100G according to Embodiment 8 is different from the antenna module 100 according to Embodiment 1 in that the circuit board 170 is provided and in that the array antenna is configured.

The circuit board 170 is electrically connected to the dielectric substrate 130 by the solder bump 34. The SiP 160 covered with the electromagnetic wave shield 60 is mounted on the circuit board 170. The circuit board 170 and the SiP 160 are electrically connected to each other by the solder bump 32.

The configuration of the radiating element 131 is the same as that of Embodiment 1. The radiating element 141F may be configured by a plurality of vias provided in the circuit board 170 for the circuit board 170 part of the plate electrode 83 shown in FIG. 10(C), which is different from the radiating element 141, in a point that the plate electrode 83 extends to the circuit board 170.

With the antenna module 100G according to Embodiment 8, since the circuit board 170 is disposed between the dielectric substrate 130 and the molded body 50, the antenna characteristics of the radiating element 131 can be enhanced by the ground electrode GND1 and the ground electrode GND3 included in the circuit board 170.

### Embodiment 9

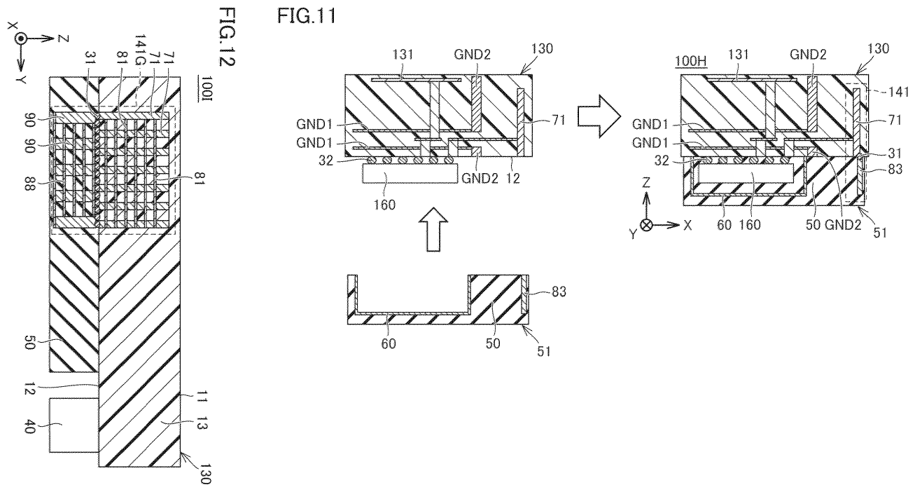

FIG. 11 is a side perspective view of an antenna module 100H according to Embodiment 9. The antenna module 100H according to Embodiment 9 is different from the antenna module 100 according to Embodiment 1 in that a mold cover 51 in which the electromagnetic wave shield 60 and the plate electrode 83 are integrated with each other by the molded body 50 is adopted. The mold cover 51 is formed of, for example, an insert mold.

As shown in FIG. 11, the antenna module 100H is configured by bonding the mold cover 51 to the second main surface 12 of the dielectric substrate 130 on which the SiP 160 is disposed. By bonding the mold cover 51 to the second main surface 12 of the dielectric substrate 130, the molded body 50 that covers the SiP 160 with the resin is disposed on the second main surface 12 side, and the plate electrode 83 is electrically connected to the via 71 on the dielectric substrate 130 side. As a result, the radiating element 141 is disposed to be straddled across the dielectric substrate 130 and the molded body 50.

### Embodiment 10

FIG. 12 is a side perspective view of an antenna module 100I according to Embodiment 10. In FIG. 12, the ground electrode GND2 disposed in the dielectric substrate 130 is not shown. The antenna module 100I according to Embodiment 10 is different from the antenna module 100 according to Embodiment 1 in that the configuration on the molded body 50 side of the radiating element disposed on the side surface 13 of the dielectric substrate 130 is realized by the plurality of copper posts 90 instead of the plate electrode.

As shown in FIG. 12, a radiating element 141G of the antenna module 100I according to Embodiment 10 has a lattice shape as a whole. A part of the radiating element 141G corresponding to the dielectric substrate 130 is formed by arranging the vias 71 filled with a conductive member and the plate electrodes 81 in a lattice shape, similarly to the radiating element 141. A part of the radiating element 141G corresponding to the molded body 50 is formed by arranging the copper posts 90 and the plate electrodes 88 in a lattice shape. A part of the radiating element 141G corresponding to the molded body 50 may be formed by the copper post 90 without providing the plate electrode 88.

### Embodiment 11

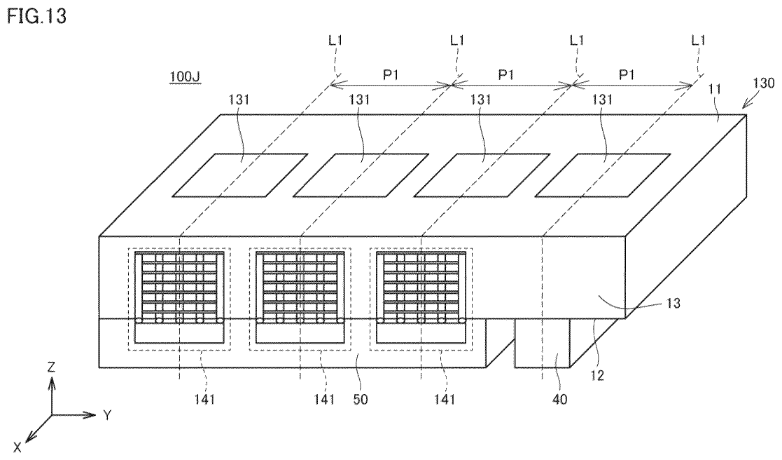

FIG. 13 is a perspective view of an antenna module 100J according to Embodiment 11. The antenna module 100J according to Embodiment 11 constitutes an array antenna in which the plurality of radiating elements 131 and 141 are disposed. In the antenna module 100J, four radiating elements 131 are disposed to face the first main surface 11 of the dielectric substrate 130, and three radiating elements 141 are disposed to face the side surface 13 of the dielectric substrate 130. The radiating elements 131 and 141 are patch antennas having a substantially square flat plate shape and are configured with the same dimensions.

Each of the radiating elements 131 faces the first main surface 11 of the dielectric substrate 130 and is disposed along the Y-axis direction at a pitch of P1. In FIG. 13, an example is shown in which the radiating element 131 is exposed on the surface of the dielectric substrate 130, but the radiating element 131 may be disposed in the inner layer of the dielectric substrate 130.

The four radiating elements 131 and the three radiating elements 141 are connected to the electronic components, such as the RFIC 110 and the PMIC 150, in the SiP 160 via the power feeding lines, similarly to the antenna module 100. The block diagram illustrated in FIG. 1 is applied to the configuration of four radiating elements 131 and three radiating elements 141. In FIG. 13, the power feeding line, the SiP 160, and the like are not shown.

In the antenna module 100J, when the radiating elements 141 are each viewed in a plan view in the normal direction (Z-axis direction) of the dielectric substrate 130, a virtual line L1 passing through the center of the radiating element 141 and extending in the X-axis direction is disposed to pass through the center of the radiating element 131.

When the dielectric substrate 130 is viewed in a plan view in the normal direction, the radiating element 141 is not provided on the virtual line L1 orthogonal to the Y-axis direction through the connector 40. However, the radiating element 131 is provided at a position where the virtual line L1 extends to the first main surface 11 of the dielectric substrate 130.

As described above, the plurality of radiating elements 141 are disposed to be arranged in the first direction (Y-axis direction) along the first main surface 11. The plurality of radiating elements 131 are disposed on the dielectric substrate 130 along the first main surface 11 in the first direction (Y-axis direction). The SiP 160 including electronic components, such as the RFIC 110 and the PMIC 150, is disposed on the second main surface 12 side. The connector 40 is disposed on the second main surface 12 side at a position adjacent to the molded body 50 in the first direction (Y-axis direction). When the dielectric substrate 130 is viewed in a plan view from a normal direction, the radiating element 141 is not provided on the virtual line orthogonal to the first direction (Y-axis direction) through the connector 40, and the radiating element 131 is provided at a position where the virtual line extends to the first main surface 11.

Therefore, in the antenna module 100J according to Embodiment 11, the number of the radiating elements 131 disposed on the first main surface 11 side of the dielectric substrate 130 is larger than the number of the radiating elements 141 disposed on the side surface 13 side of the dielectric substrate 130. Since it is necessary to dispose the connector 40 on the second main surface 12 of the dielectric substrate 130, the radiating element 141 cannot be provided at the position of the side surface 13 of the dielectric substrate 130 corresponding to the connector 40.

However, since there is no constraint on the space by disposing the connector 40 on the first main surface 11 side of the dielectric substrate 130, more radiating elements 131 can be disposed than on the side surface 13 side of the dielectric substrate 130. As a result, according to the antenna module 100J of Embodiment 11, even when the connector 40 is provided on the second main surface 12 of the dielectric substrate 130, an antenna module can be provided in which a large number of radiating elements 131 and 141 are disposed to maximize area efficiency.

The relationship between the virtual line L1 and the radiating elements 131 and 141, which is described as Embodiment 11, is merely an example. For example, the radiating element 131 and the radiating element 141 may be disposed such that a virtual line L1 passing through the radiating element 141 passes between the adjacent radiating elements 131 and 131.

In the present disclosure, it is intended that any two or three or more of the above-described embodiments can be combined as appropriate.

The embodiment disclosed herein is required to be considered to be an example and not restrictive in all respects. The scope of the present invention is indicated by the CLAIMS rather than the description of the above-described embodiment, and is intended to include all changes within the meaning and range of equivalents to the CLAIMS.

### REFERENCE SIGNS LIST

10 COMMUNICATION DEVICE
11 FIRST MAIN SURFACE
12 SECOND MAIN SURFACE
13 SIDE SURFACE
21, 22, 23, 21A, 21B, 22A, 22B, 21C, 22C POWER FEEDING LINE
25, 26 WIRING
31 to 34 SOLDER BUMP
40 CONNECTOR
51 MOLD cover
50 MOLDED BODY
60 ELECTROMAGNETIC WAVE SHIELD
61 WALL SURFACE
71 to 73 VIA
81 to 88 PLATE ELECTRODE
90 COPPER POST
100, 100A to 100J ANTENNA MODULE
110 RFIC
111A to 111H, 113A to 113H, 117A, 117B SWITCH
112AR to 112 HR LOW-NOISE AMPLIFIER
112AT to 112HT POWER AMPLIFIER
114A to 114H ATTENUATOR
115A to 115H PHASE SHIFTER
116A, 116B SIGNAL SYNTHESIZER/POWER SPLITTER
118A, 118B MIXER
119A, 119B AMPLIFIER CIRCUIT
120 ANTENNA DEVICE
130 DIELECTRIC SUBSTRATE
131, 131B RADIATING ELEMENT
141, 141A to 141G RADIATING ELEMENT
150 PMIC
160 SiP
170 CIRCUIT BOARD
200 BBIC
1311, 1312 RADIATION ELECTRODE
1411, 1412 RADIATION ELECTRODE
GND1 to GND3 GROUND ELECTRODE
L1 VIRTUAL LINE
P1 PITCH

1. An antenna module comprising:
a substrate having a first main surface and a second main surface facing in opposite directions;
a first radiating element that is disposed along the first main surface;
an electronic component that is disposed on a second main surface side and is electrically connected to the first radiating element; and
a molded body that is disposed on the second main surface side and covers the electronic component with a resin, wherein
the first radiating element is disposed to straddle the substrate and the molded body.

2. The antenna module according to claim 1, further comprising:
a second radiating element that is disposed along the first main surface.

3. The antenna module according to claim 1, wherein
the first radiating element is a flat plate-shaped electrode.

4. The antenna module according to claim 1, wherein
the first radiating element includes a first element part that is disposed on the substrate and a second element part that is disposed in the molded body, and
an electrode density of an electrode surface of the first element part is different from an electrode density of an electrode surface of the second element part.

5. The antenna module according to claim 4, wherein
the first element part has a mesh shape, and
the second element part has a flat plate shape.

6. The antenna module according to claim 4, wherein
the first element part includes a plurality of vias that are disposed in a normal direction of the substrate, and a conductive member that connects adjacent vias among the plurality of vias.

7. The antenna module according to claim 6, wherein
the plurality of vias are disposed in a staggered pattern.

8. The antenna module according to claim 1, wherein
the first radiating element includes a first electrode and a second electrode having a size different from a size of the first electrode.

9. The antenna module according to claim 1, wherein
the first radiating element includes a first electrode and a second electrode, and
an offset direction from a center of a power feeding point in the first electrode is different from an offset direction from a center of a power feeding point in the second electrode.

10. The antenna module according to claim 1, further comprising:
a ground electrode that is disposed to face the first radiating element, wherein
the ground electrode is disposed to straddle the substrate and the molded body.

11. The antenna module according to claim 10, further comprising:
an electromagnetic wave shield that covers the electronic component in the molded body, wherein
the electromagnetic wave shield constitutes a part of the ground electrode.

12. The antenna module according to claim 10, wherein,
when the substrate is viewed from a side view in a side surface direction of the first radiating element, both end portions of the first radiating element extend toward the ground electrode.

13. The antenna module according to claim 12, wherein,
of both the end portions of the first radiating element, a first end portion is disposed in the substrate and a second end portion is disposed on a surface of the molded body,
when the substrate is viewed from a side view in a side surface direction of the first radiating element, the first end portion extends toward the ground electrode from an inside of the ground electrode with respect to an end of the ground electrode, and
when the substrate is viewed from the side view in the side surface direction of the first radiating element, the second end portion extends toward the ground electrode from an outside of the ground electrode with respect to the end of the ground electrode.

14. The antenna module according to claim 10, wherein
the first radiating element is disposed in an aspect in which the first radiating element is inclined toward the ground electrode with a bonding surface between the substrate and the molded body as a boundary.

15. The antenna module according to claim 10, wherein,
when the substrate is viewed from a side view in a side surface direction of the ground electrode, both end portions of the ground electrode extend toward the first radiating element.

16. The antenna module according to claim 1, further comprising:
a circuit board that is disposed between the second main surface and the electronic component, wherein
the electronic component is mounted on the circuit board.

17. The antenna module according to claim 2, further comprising:
a circuit board that is disposed between the second main surface and the electronic component, wherein
the electronic component is mounted on the circuit board.

18. An antenna module comprising:
a substrate having a first main surface and a second main surface facing in opposite directions;
a plurality of first radiating elements that are disposed along the first main surface;
an electronic component that is disposed on a second main surface side and is electrically connected to the plurality of first radiating elements; and
a molded body that is disposed on the second main surface side and covers the electronic component with a resin, wherein
each of the plurality of first radiating elements is disposed to straddle the substrate and the molded body.

19. An antenna module comprising:
a substrate having a first main surface and a second main surface facing in opposite directions;
a plurality of first radiating elements that are disposed to be arranged in a first direction along the first main surface;
a plurality of second radiating elements that are disposed along the first main surface in the first direction and disposed on the substrate;
an electronic component that is disposed on a second main surface side and is electrically connected to the first radiating element and the second radiating element;
a molded body that is disposed on the second main surface side and covers the electronic component with a resin; and
a connector that is disposed on the second main surface side at a position adjacent to the molded body in the first direction, wherein
the first radiating element is disposed to straddle the substrate and the molded body, and
when the substrate is viewed from a plan view in a normal direction, the first radiating element is not provided on a virtual line passing through the connector and orthogonal to the first direction, and the second radiating element is provided at a position where the virtual line extends to the first main surface.

20. A communication device comprising:
the antenna module according to claim 1.
